(19) United States
(12) Patent Application Publication
(10) Pub. No.: US 2024/0140696 A1
(43) Pub. Date: May 2, 2024

(54) DEVICE FOR STORING A LIQUID THAT IS PROVIDED WITH A FLOATING COVER, AND USE OF SUCH A DEVICE

(71) Applicant: PEP TECHNOLOGIES, LE CHEYLARD (FR)

(72) Inventor: Philippe PERRIER, LE CHEYLARD (FR)

(21) Appl. No.: 18/279,266

(22) PCT Filed: Mar. 10, 2022
(86) PCT No.: PCT/FR2022/050427

§ 371 Date: Aug. 29, 2023

(30) Foreign Application Priority Data
Mar. 11, 2021 (FR) FR2102396

(51) Int. Cl. B65D 88/40; B08B 9/093; B65D 88/54

(52) U.S. Cl. CPC B65D 88/40; B08B 9/093; B65D 88/544; B08B 2209/08

(57) ABSTRACT

Equipment (1) for storing a liquid (L) includes a storage tank (2) having a bottom (4) from which a cylindrical wall (6) closed by a ceiling (5) rises, the tank being provided with washing nozzles (10) and with at least one liquid supply inlet (8) and at least one liquid outlet (9); a cover (3) mounted inside the tank and arranged to float on the liquid present in the tank; the cover (3) being mounted in the tank to delimit with the cylindrical wall, a communication space (11) on either side of the cover, configured to allow the vertical displacement of the cover when the level of the liquid changes in the tank and in that the equipment includes a system (12) for bearing the cover on the bottom of the tank keeping the lower face (3a) of the cover at a distance from the bottom of the tank.

### TECHNICAL FIELD

The object of the invention relates to the technical field of storage equipment for liquids which must be preserved in contact with air so that they do not lose their properties or characteristics.

The object of the invention finds a particularly advantageous application for the storage of volatile and/or oxidation-sensitive liquid products such as wine, but the object of the invention can also apply to other other liquid products such as oil, (volatile) spirits or fruit juices for example.

### PRIOR ART

In the technical field of wine storage, it is known that it should be stored away from oxygen to prevent its oxidation. A first category of techniques consists in introducing an inert gas into the top of the storage tank as proposed for example by patent GB 2 330 761. Such techniques are relatively complex and expensive to implement, and risk modifying the organoleptic properties of the wine.

A second category of techniques consists of placing in the storage tank a cap or a roof floating on the liquid. For example, patent FR 1 541 092 proposes a floating cover provided at its periphery with an inflatable seal. This solution, which is particularly suitable when the liquid level is fixed, does not make it possible to follow the variations in the liquid level in the tank. The variations in the liquid level in the tank appear in particular when the storage tank supplies with liquid a machine for drawing off or filling containers.

For a variable-level storage tank, patent FR 2 627 467 discloses a floating cover provided with a vent and designed to adhere to the liquid thanks to a suction cup effect. The gap between the cover and the tank is covered with a layer of oil or with a solid seal. The implementation of a sealing oil proves to be delicate and is not part of the inputs authorized in wine in the French regulations. In addition, the cleaning of the tank and of the cover constitutes an operation delicate to conduct. Document WO 96/18559 describes a sealed reservoir including a tank for receiving a liquid on the surface from which floats a cover provided with a skirt diving into a sealing chamber surrounding the tank. Such a reservoir has a relatively complex design and cannot be easily cleaned. Document JP 2002321791 describes a tank having an oblique bottom and a floating cover. Again, the gap between the cover and the tank is filled with oil. A washing nozzle is positioned on the bottom of the tank, under an attachment means, which does not allow easy and effective cleaning of the tank and the floating cover. Document CN 104709624 describes a tank with a floating cover provided at its periphery with a leather seal.

### DISCLOSURE OF THE INVENTION

The present invention aims to overcome the drawbacks of the state of the art by proposing a new equipment for the storage of liquid, adapted to limit the contact of air with the liquid, while adapting to variations in the liquid level without special intervention.

Another object of the invention is to propose a new equipment for the storage of liquid having a simple design and which can be easily cleaned.

To achieve such objectives, the object of the invention relates to an equipment for storing a liquid comprising:
a storage tank for the liquid having a bottom from which a cylindrical wall closed by a ceiling rises, the tank being provided with washing nozzles and with at least one liquid supply inlet and at least one liquid outlet;
a cover having a lower face and an upper face, mounted inside the tank and arranged to float on the liquid present in the tank, the cover being mounted in the tank to delimit with the cylindrical wall, a communication space on either side of the cover, configured to allow the vertical displacement of the cover when the level of the liquid changes in the tank;
a system for bearing the cover on the bottom of the tank keeping the lower face of the cover at a distance from the bottom of the tank.

The storage equipment according to the invention advantageously has either of the following characteristics, or a combination of two or more of the following characteristics:
the cover includes an upper face of conical shape;
the cover includes a lower face of conical shape;
the system for bearing the cover comprises feet carried by the cover to bear on the bottom of the tank when the cover stops floating;
the tank includes washing nozzles protruding from the ceiling of the tank on which the upper face of the cover comes into abutment keeping the upper face of the cover at a distance from the ceiling of the tank;
the cover includes, at its periphery, studs for cooperation with the cylindrical wall of the tank to ensure the centering of the cover during its vertical displacement;
the tank is made of a transparent or translucent material.

Another object of the invention relates to the use of equipment in accordance with the invention in a phase of supplying said equipment during which the cover floats on the liquid by moving vertically to follow the liquid level changing in the tank depending on the arrival and/or the exit of liquid towards/from a filling machine.

The use of the equipment in accordance with the invention advantageously has either of the following characteristics, or a combination of two or more of the following characteristics:
a phase of cleaning the tank precedes or follows a phase of supplying with liquid the filling machine, and during which the tank washing nozzles deliver a cleaning liquid spraying the upper face of the cover and flowing through the space delimited between the cover and the cylindrical wall;
a phase of cleaning the tank precedes or follows a phase of supplying with liquid the filling machine, and during which the supply inlet(s) of the tank and/or the outlets deliver(s) a washing liquid to immerse the cover so that, by floating, the cover bears on the cleaning nozzles and is completely immersed in the washing liquid present in the tank.

### BRIEF DESCRIPTION OF THE DRAWINGS

FIG. 1A is a schematic cross-sectional view showing one exemplary embodiment of a liquid storage equipment according to the invention, empty.

FIG. 1B is a schematic sectional view showing one exemplary embodiment of a liquid storage equipment according to the invention, partially filled with liquid.

FIG. 2A is a schematic sectional view showing the storage equipment according to the invention during its cleaning by nozzles.

FIG. 2B is a schematic sectional view showing the storage equipment according to the invention during its cleaning by immersion.

### DESCRIPTION OF THE EMBODIMENTS

The invention relates to an equipment for storing 1 a liquid L. The invention finds a particular application in the storage of air-sensitive liquids, that is to say liquids that degrade on contact with air, by oxidation for example, such as oil, milk or wine.

As illustrated in the Figures, the storage equipment 1 according to the invention comprises a storage tank 2 and a floating cover 3.

In the context of the invention, the storage tank 1 has a cylindrical shape. It is composed of a bottom 4 and of a ceiling 5 connected together by a wall 6. The bottom 4 and the ceiling 5 have both a circular shape, of substantially identical size. The wall 6 has a cylindrical shape and is hermetically closed at both ends by the bottom 4 on the one hand and the ceiling 5 on the other hand. Of course, the sealed assembly of the wall 6 with the bottom 4 and the ceiling 5 is carried out in any appropriate manner. In the illustrated exemplary embodiment, the wall 6 is perpendicular to the ceiling 5 but it is clear that the ceiling 5 can have a shape different from a planar plate. Advantageously, the bottom 4 has a shape adapted to avoid retention or stagnation of liquid. As can be seen from the exemplary embodiment illustrated in the drawings, the bottom 4 has a conical shape whose top is directed towards the inside of the tank.

The storage tank 2 can be made of any material compatible with the liquid L and resistant to repeated cleaning, advantageously also resistant to temperature variations, and preferably having low surface adhesion. For example, the storage tank 2 is made of stainless steel. Advantageously, the storage tank 2 or part of the storage tank 2 and particularly its wall 6, is preferably made of a translucent or transparent material, for example glass or the like, which makes it possible to visualize the liquid level L in the storage tank and also to visualize its proper cleaning.

The storage tank 2 further comprises at least one liquid supply inlet 8 and at least one liquid outlet 9, and preferably one liquid supply inlet 8 and several liquid outlets 9. Advantageously, the liquid L outlet(s) 9 are positioned in the lower part of the storage tank 2, so that the liquid L can completely flow out of the storage tank 2, without presenting retention zones for the liquid 2. Preferably, the liquid supply inlet 8 is located in the bottom 4 of the storage tank 2 at the level of its central part corresponding to the top of the bottom 4. According to one particular embodiment, the storage tank 2 includes several liquid outlets 9, located in the bottom 4 of the storage tank 2, at the periphery of the bottom 4 to be located in the lower part of the bottom. In the case where the storage tank 2 includes two liquid outlets 9 then these two outlets are disposed in a diametrically opposite manner. In the case of a greater number of liquid outlets 9 then these outlets 9 are evenly distributed at the periphery of the bottom 4.

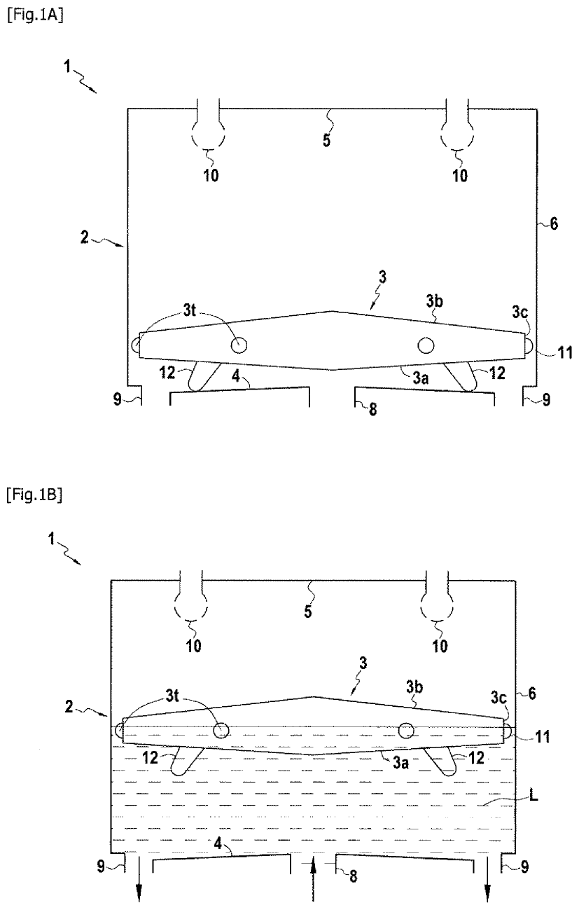

The liquid L supply inlet(s) and the liquid L outlet(s) 9 can be of identical or different shapes, and are circular in shape in the exemplary embodiment illustrated in FIG. 1A. Although not illustrated, various other geometries for the supply inlets 8 and the liquid L outlets 9 can be envisaged within the scope of the invention. The supply inlets 8 and the liquid outlets 9 are intended to be fitted with a pipe, for example to convey the liquid entering or leaving the storage tank, and possibly with a valve to allow the liquid L to enter or leave the storage tank 2, or on the contrary to obturate the flow of liquid.

The storage tank 2 according to the invention also comprises at least one washing nozzle 10, and preferably three washing nozzles 10 advantageously disposed in a triangle so that the floating cover 3 can bear centered above in case of immersion of the floating cover. The washing nozzles 10 can be of any type known per se. Particularly, they can be fixed or rotating, of any shape, and spraying a mist or, preferably, a jet of washing liquid in all directions inside the storage tank. The washing liquids that can be used in the context of the invention can be of any type known per se, such as water for example.

The washing nozzles 10 can be positioned in different places of the storage tank 2, that is to say protruding from the wall 6 and/or from the bottom 4 and/or from the ceiling 5 of the storage tank 2, and distributed in an even or uneven manner. Advantageously, the equipment 1 according to the invention includes at least one, and preferably three washing nozzles 10 which protrude from the ceiling 5 of the storage tank 2, distributed in an even manner in order to allow a better washing of the equipment according to the invention. The washing nozzles 10 are advantageously prominent with respect to the ceiling 5 to act as a stop for the cover 3, as will be detailed later.

The equipment 1 according to the invention further includes a cover 3, having a lower face 3a, an upper face 3b and a peripheral area 3c, mounted inside the tank 2. The cover 3 is mounted inside the storage tank between the bottom 4 and the ceiling 5.

The cover 3 can be of various shapes, it being understood that it delimits with the wall 6 a communication space 11 on either side of the cover 3. In other words, a communication space 11 is present between the cover 3, and more specifically its peripheral area 3c and the wall 6. The cover 3 does not cooperate in a sealed manner with the wall 6. The communication space 11 allows a displacement of the cover according to the height of the wall 6 of the storage tank 2 when the liquid level L in the tank 2 changes.

According to one preferred embodiment illustrated in FIG. 1B, the peripheral area 3c of the cover 3 has a circular shape, with a diameter substantially smaller than the diameter of the cylindrical wall 6 of the storage tank 2. The communication space 11 is in this case ring-shaped.

According to one preferred embodiment, the cover 3 includes at its periphery studs 3t for cooperation with the wall 6 of the storage tank 2, which allows the centering of the cover 3 during its vertical displacement caused by a change of the liquid level L in the storage tank 2. Advantageously, several studs 3t are disposed protruding from the peripheral area 3c of the cover, and particularly at least three each having the shape of a half-phere for example. The studs 3t then serve as guides in vertical translation for the cover 3. The outgrowth of the studs 3t delimits the width of the communication space 11 between the peripheral area 3c of the cover and the wall 6 of the storage tank 2.

The lower face 3a and the upper face 3b of the cover 3 can be of various geometries independently of each other. According to one particularly advantageous embodiment, the lower 3a and upper 3b faces of the cover 3 are of identical shape and preferably of conical shape with the convexity facing the outside of the cover 3. The conical shape of the upper face 3b makes it possible to avoid liquid retention zones L on the cover while facilitating its cleaning. Furthermore, a lower face 3a of conical shape prevents the formation of air bubbles when filling the storage tank 2, particularly when the liquid L supply inlet 8 is located on the bottom 4 of the storage tank 2.

The cover 3 is configured to float on the liquid L present in the storage tank 2 while remaining more or less immersed in the liquid while keeping at least its upper face 3b not immersed. For this, the cover 3 may have a more or less hollow internal structure in order to obtain suitable buoyancy according to the density of the liquid. According to one preferred embodiment, the cover 3 is hollow. Thus, the cover 3 can remain on the surface of the liquid L present in the tank, and follow its vertical movements depending on the filling or emptying of the storage tank 2, which thus makes it possible to properly isolate the liquid L from air and thus limit or even protect it from any risk of degradation and/or evaporation. The unprotected surface of liquid L limited to the peripheral area 3c of the cover is negligible and the cover 3 follows the liquid level L in the tank 2. The cover 3 is preferably made of stainless steel to facilitate its cleaning and for its resistance to heat and cleaning chemicals.

The cover 3 includes a system for bearing 12 the cover 3 on the bottom of the tank 2. This bearing system 12 can be of different shapes and can protrude either from the bottom 4 or, preferably, from the lower face 3a of the cover 3. According to one preferred embodiment, the bearing system 12 is in the form of feet, and particularly comprises at least three feet, protruding from the lower face 3a of the cover 3, by being evenly or unevenly distributed thereon. According to this embodiment, the free end of the feet is preferably rounded in order to have a minimum grip and then allow better cleaning. Whatever the shape of the bearing system 12, it is important that its positioning does not hinder the arrival and the exit of the liquid L in/from the tank 2.

This bearing system 12 makes it possible to maintain the lower face 3a of the cover 3 at a distance from the bottom 4 of the tank when the liquid level in the tank is low or even zero: the cover 3 then ceases to float and comes into abutment on the bottom 4 thanks to the bearing system 12. For this, the height of the bearing system 12 is neither too high for the liquid L to be protected even if a small volume is present in the tank 2, nor too low for the cleaning under the cover 3, and in particular of the bottom 4 and of the lower face 3a of the cover 3 to be effective.

Similarly, the upper face 3b of the cover 3 is kept at a distance from the ceiling 5 when the cover 3 occupies its maximum high position inside the storage tank 2. Indeed, the storage tank 2 comes in abutment in the example illustrated, on the washing nozzles 10 protruding from the ceiling 5 of the storage tank 2. Thus, the upper face 3b of the cover 3 is kept at a distance from the ceiling 5 even when the tank 2 is completely filled with liquid L. It should be noted that the cover 3 is bearing centered on the washing nozzles thanks to the triangular distribution of the washing nozzles 10.

When the storage tank 2 is empty of liquid, the cover 3 is in abutment by the bearing system 12 on the bottom of the storage tank 2 while leaving the supply inlet 8, the two liquid L outlets 9 and the bottom 4 of the tank 2 unobstructed, as represented in FIG. 1A.

FIG. 1B represent vertical arrows showing the vertical displacement of the liquid L in the supply inlet 8 and the two outlets 9. Depending on the flow rate in the supply inlet 8 and the two outlets 9, the liquid level L in the tank 2 varies. The cover 3, which floats on the liquid, rises or falls depending on the variation in the liquid L level.

The invention also relates to the use of an equipment in accordance with the invention, in a phase of supplying a filling machine. The filling machine (not represented in the Figures) is a machine making it possible to introduce a determined volume of liquid L into containers, such as bottles or flasks for example. The filling machine is connected to the outlets 9 of the equipment 1. Thus, the equipment 1 makes it possible to store the liquid L protected from the air, while waiting for its introduction into the containers.

In the context of the invention, as illustrated in FIGS. 1A and 1B, the liquid L enters the storage tank 2 via the liquid supply inlet 8 and leaves it via the outlets 9. When the liquid level L in the tank is zero or very low, the cover 3 is bearing on the bearing system 12, as illustrated in FIG. 1k

Depending on the liquid L flow rate entering and leaving the tank 2, the liquid level varies (i.e. rises or falls). As illustrated in FIG. 1B, when the volume of liquid L in the tank 2 increases or decreases, the cover 3 floats on the liquid, by following its vertical movements. The upper face 3b of the cover 3 is then not in contact with the liquid L. On the other hand, depending on the nature of the cover (nature of the material constituting or not constituting the cover and hollow cover) and the nature of the liquid (particularly its density), the peripheral area 3c of the cover 3 can be completely or partially immersed in the liquid L. In general, its lower face 3a is completely immersed in the liquid L. Advantageously, the design of the cover 3 does not allow the liquid to pass above the peripheral area 3c.

As soon as liquid L is present in the tank 2, it is possible to supply a filling machine with liquid.

According to one particularly advantageous aspect of the invention, the equipment 1 is easily and efficiently cleaned. This cleaning can be carried out before and/or after a phase of supplying a filling machine. This cleaning is preferably carried out when the tank 2 has been completely emptied, in particular to supply a filling machine.

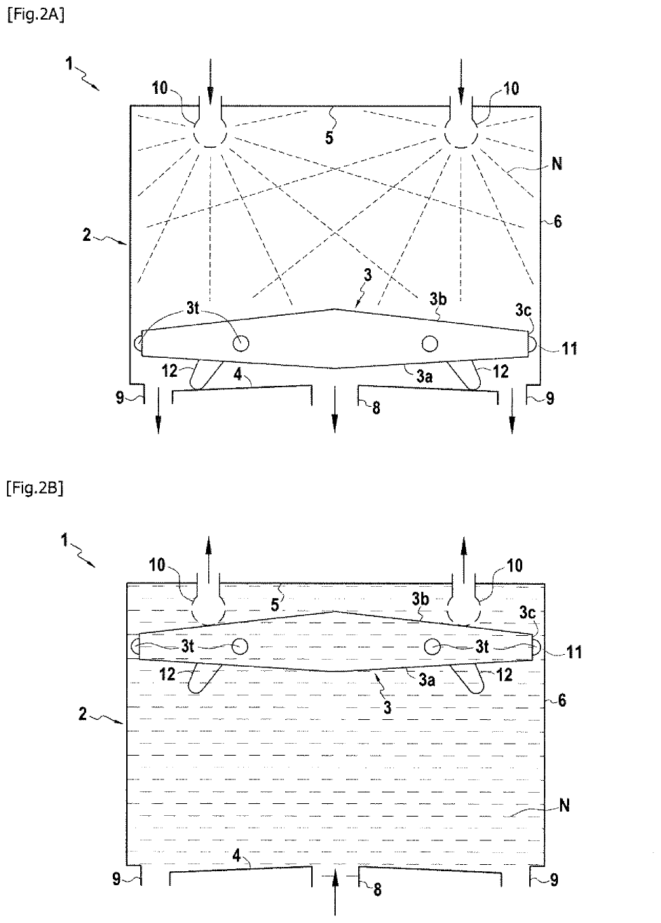

According to a first embodiment, the cleaning of the equipment 1 is carried out by the spraying or projection of a washing liquid N thanks to the washing nozzles 10, as illustrated in FIG. 2A. The washing liquid N leaving the washing nozzles 10 is projected in all directions so that the ceiling 5, the wall 6 and the upper face 3b of the cover 3 are sprayed and cleaned by this washing liquid. This washing liquid then flows via the communication space 11, between the studs 3t, to ensure the cleaning of the lower part of the tank located below the cover 3.

The washing liquid is discharged from the storage tank by the liquid supply inlet 8 and/or the liquid outlets 9.

Advantageously, the upper face 3b of the cover 3 has a conical shape, which allows a good flow of the washing liquid on the cover without any retention is thereon.

Advantageously, the lower face 3a of the cover 3 has a conical shape, which allows a runoff of the washing liquid and thus a cleaning the lower face 3a of the cover 3.

According to a second embodiment, the equipment 1 is cleaned by completely filling the tank 2 with washing liquid, as illustrated in FIG. 2B.

For this, the tank 2 is filled with washing liquid N by feeding the washing liquid through the supply 8 and/or the outlets 9. Of course, the unused supply 8 and/or outlets 9 for the feeding of the washing liquid are then closed, for example by a valve. The washing liquid N is introduced inside the storage tank 6 to immerse the cover 3 and bring it, by flotation, to bear on the washing nozzles 10. Thanks to the triangular distribution of the washing nozzles 10, the cover 3 bears centered on the washing nozzles. Advantageously, the tank 2 is completely filled with washing liquid N to allow the total immersion of the cover 3 by the washing liquid. The cover 3, the bottom 4, the ceiling 5 and the wall 6 are then in contact with the washing liquid, which ensures their proper cleaning.

Advantageously, the washing product is discharged by the washing nozzles 10 making it possible to maintain a circulation of the washing liquid inside the storage tank. The washing liquid can then circulate freely from the lower part to the upper part of the tank 2, and vice versa, via the communication space 11, through the studs 3t. The shape of the studs, as well as the preferred conical shape of the lower face 3a and of the upper face 3b of the cover 3, allows easy and effective cleaning without accumulation and stagnation of air bubbles.

The cleaning can be advantageously carried out by first spraying the washing liquid through the washing nozzles 10 as illustrated in FIG. 2A then, secondly, by completely filling the tank 2 with washing liquid as illustrated in FIG. 2B. The consecutive cleaning according to the two described embodiments allows optimum cleaning of the tank.

At the end of cleaning, the storage tank 2 is emptied of any washing liquid thanks to the outlets 9 and/or to the supply 8 and is possibly dried.

1. An equipment (1) for storing a liquid (L) comprising:
a storage tank (2) for the liquid (L) having a bottom (4) from which a cylindrical wall (6) closed by a ceiling (5) rises, the tank (2) being provided with washing nozzles (10) protruding from the ceiling (5) of the tank (2), and with at least one liquid (L) supply inlet (8) and at least one liquid (L) outlet (9);
a cover (3) having a lower face (3a) and an upper face (3b), mounted inside the tank (2) and arranged to float on the liquid (L) present in the tank (2);
characterized in that the cover (3) is mounted in the tank (2) to delimit with the cylindrical wall (6), a communication space (11) on either side of the cover (3), configured to allow the vertical displacement of the cover (3) when the level of the liquid (L) changes in the tank (2) and in that the equipment (1) includes a system for bearing (12) the cover (3) on the bottom (4) of the tank (2) protruding either from the bottom (4) of the tank or from the lower face (3a) of the cover (3).

2. The equipment (1) according to claim 1, according to which the cover (3) includes an upper face (3b) of conical shape.

3. The equipment (1) according to claim 1, according to which the cover (3) includes a lower face (3a) of conical shape.

4. The equipment (1) according to claim 1, according to which the system for bearing (12) the cover (3) comprises feet carried by the cover (3) to bear on the bottom (4) of the tank (2) when the cover (3) stops floating.

5. The equipment (1) according to claim 1, according to which the cover (3) includes, at its periphery, studs for cooperation (3t) with the cylindrical wall (6) of the tank (2) to ensure the centering of the cover (3) during its vertical displacement.

6. The equipment (1) according to claim 1, according to which the tank (2) is made of a transparent or translucent material.

7. A use of equipment (1) according to claim 1, in a phase of supplying with liquid (L) a filling machine during which the cover (3) floats on the liquid (L) by moving vertically to follow the liquid (L) level changing in the tank (2) depending on the arrival of liquid (L) and the exit of liquid (L) towards/from the filling machine.

8. The use according to claim 7, according to which a phase of cleaning the tank (2) precedes or follows a phase of supplying with liquid the filling machine, and during which the washing nozzles (10) of the tank (2) deliver a cleaning liquid spraying the upper face (3b) of the cover (3) and flowing through the space delimited between the cover (3) and the cylindrical wall (6).

9. The use according to claim 7, according to which a phase of cleaning the tank (2) precedes or follows a phase of supplying with liquid the filling machine, and during which the at least one liquid supply inlet (8) of the tank (2) and/or the at least one liquid (L) outlet (9) delivers(s) a washing liquid to immerse the cover (3) so that, by flotation, the cover bears on the washing nozzles (10) and is completely immersed in the washing liquid present in the tank.
